(19) United States
(12) Patent Application Publication
(10) Pub. No.: US 2002/0185340 A1
(43) Pub. Date: Dec. 12, 2002

(54) Electronic controlled brake device

(76) Inventor: Seiichi Kojima, Aichi-ken (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/163,463

(22) Filed: Jun. 7, 2002

(30) Foreign Application Priority Data
Jun. 7, 2001 (JP) 2001-173052

(51) Int. Cl. F16D 55/16

(52) U.S. Cl. 188/72.8; 188/196 V

(57) ABSTRACT

An electronic controlled brake device comprises a ball screw for converting a rotational torque of an electric motor to an axial impulsive force of a spindle, a brake pad pressed against a disc rotor by the axial impulsive force of the spindle for generating a braking force, electronic control unit for controlling a drive of the electric motor and braking operation judging device for judging a braking operational condition. The spindle is moved from an initial position in a predetermined distance by the electric motor so as to back away from the disc rotor when the non braking operational condition is judged by braking operation judging device and thereafter is returned to the initial position by the electric motor.

### CROSS REFERENCE TO RELATED APPLICATIONS

This application is based on and claims priority under 35 U.S.C. § 119 with respect to a Japanese Patent Application 2001-173052, filed on Jun. 7, 2001, the entire content of which is incorporated herein by reference.

### FIELD OF THE INVENTION

This invention relates to an electronic controlled brake device. More particularly, the present Invention pertains to an electronic controlled brake device in which a brake pad is pressed against the disc rotor by an electric motor for obtaining a braking force.

### BACKGROUND OF THE INVENTION

A conventional electronic controlled brake device of this kind is disclosed In, for example, Japanese Patent Laid-Open Publication No. 63-266228. In this device, a rotational torque of an electric motor is converted to an impulsive force of a spindle by a planetary gear unit and a ball screw. Thereby, a brake pad Is pressed against a disc rotor by the spindle and a braking force Is obtained.

In this prior device, an axial moving distance of the spindle corresponding to a piston of a hydraulic brake device for pressing the brake pad against the disc rotor is around 1 mm and is small. Further, as shown in FIG. 3, an axial moving distance of a male screw 147 of the ball screw formed on the spindle Is also around 1 mm and is also small. A lead L of the ball screw is around 2 to 4 mm. Accordingly, la female screw 145 of the ball screw does not go Into a 360-degree roll until the brake pad Is pressed against the disc rotor for obtaining the braking force after the spindle is moved from its initial position.

This means that a ball 148 which rolls in a screw groove formed between a screw groove 147a of the male screw 147 and a screw groove 145a of the female screw 145 while rotating on Its axis being at right angle to the screw groove exits. A portion of such ball 148 contacting with the screw groove while rolling In the screw groove wears partially and the durability of the ball screw is decreased.

In the ball screw, circulators (ball circulating means) 149, 150 for circulating balls 148 are provided. If the ball proceeds in the circulators 149, 150, the direction of the rotational axis thereof Is changed and the portion contacting with the screw groove is changed. In such ball, a partial wear hard to generate. However, in the circumstance which the female screw 145 does not go into a 360-degree roll, most of the ball can not proceed in the circulators 149, 150 and therefore the portion of such ball 148 contacting with the screw groove while rolling In the screw groove wears partially. As a result, the durability of the ball screw is decreased.

If the moving distance of the ball screw is increase by a lever mechanism and as many balls as possible are proceeded in the circulators, the balls is prevented from wearing partially and the durability of the ball screw Is prevented from decreasing. According to these measures, however, a size of the brake device is increased.

A need exists for an electronic brake device which can improve the durability of the ball screw without increasing in size.

### SUMMARY OF THE INVENTION

According to an aspect of the present Invention, an electronic controlled brake device comprises a ball screw- for converting a rotational torque of an electric motor to an axial impulsive force of a spindle, a brake pad pressed against a disc rotor by.the axial impulsive force of the spindle for generating a braking force, electronic control means for controlling a drive of the electric motor and braking operation judging means for judging a braking operational condition, wherein the spindle Is moved from an initial position in a predetermined distance by the electric motor so as to back away from the disc rotor when the non braking operational condition is judged by braking operation judging means and thereafter is returned to the initial position by the electric motor. According to the other aspect of the present invention, an electronic controlled brake device comprises a ball screw for converting a rotational torque of an electric motor to an axial Impulsive force of a spindle, a brake pad pressed against a disc rotor by the axial, impulsive force of the spindle for generating a braking force, electronic control means for controlling a drive of the electric motor and braking operation judging means for judging a braking operational condition, wherein the spindle is moved from an initial position in a predetermined time by the electric motor so as to back away from the disc rotor when the non braking operational condition Is judged by braking operation judging means and thereafter is returned to the initial position by the electric motor.

### BRIEF DESCRIPTION OF THE DRAWING FIGURES

A more complete appreciation of the invention and other advantages thereof will be readily obtained as the same becomes better understood by reference to the following detailed description when considered In connection with the accompanying drawings, in which:

FIG. 1 is a schematic illustration of an electronic controlled brake device of an embodiment in accordance with the present Invention;

FIG. 2 is a cross sectional view of an electronic controlled brake of an embodiment In accordance with the present invention; and

FIG. 3 is a cross sectional view of a conventional ball screw.

### DETAILED DESCRIPTION OF THE INVENTION

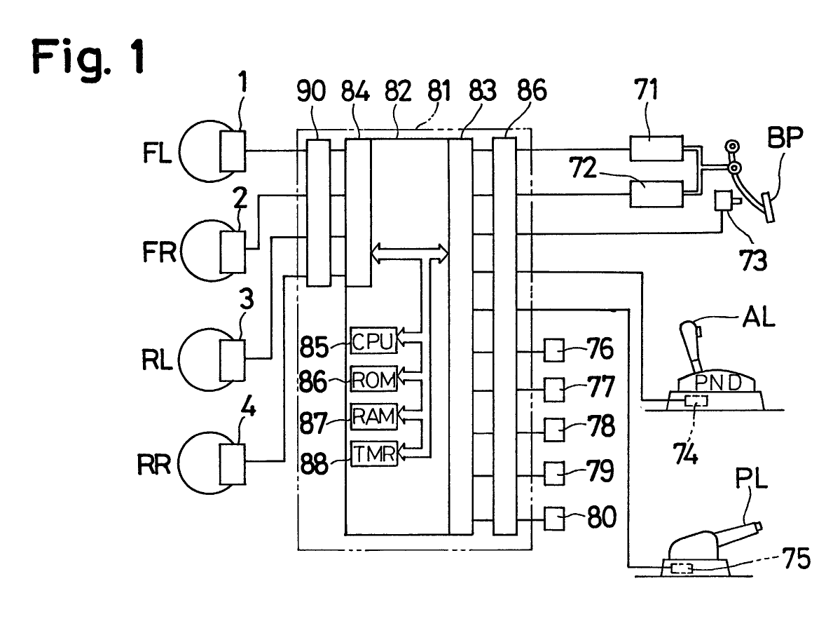

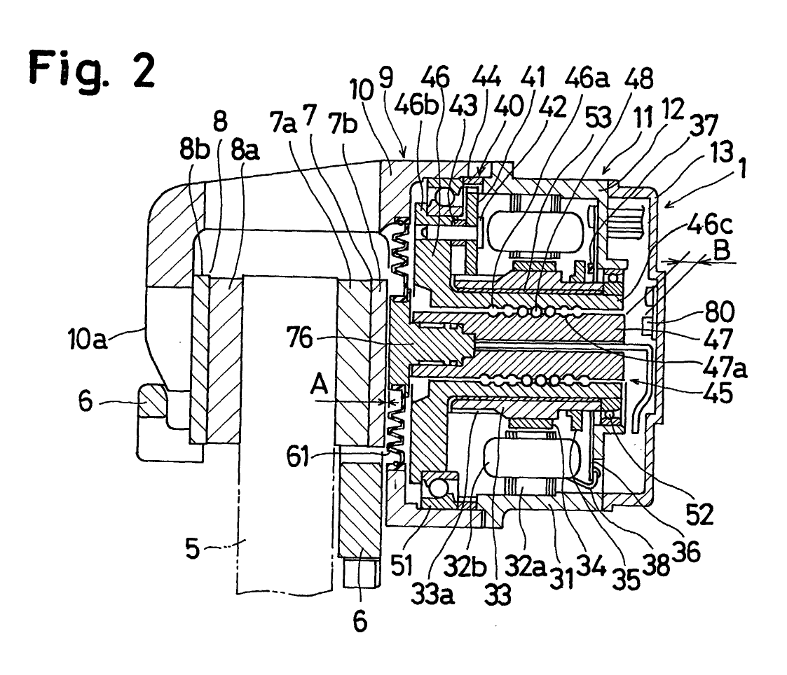

Having generally described the present invention, a further understanding of the invention can be obtained now according to an embodiment of the present invention with reference to FIGS. 1 to 2 in accompanying drawings.

FIG. 1 is a schematic illustration of an electronic controlled brake device of the embodiment. In FIG. 1, an electric control unit 81 is provided with a micro computer 82 which includes a CPU 85, a ROM 86, RAM 87, a timer (TMR) 88, an input port 83 and an output port 84. The CPU 85, the ROM 86, the RAM 87, the timer 88, the input port 83 and the output port 84 are mutually connected via bus.

The input port 83 is connected to a pedal depressing force sensor 71 for detecting a pedal depressing force applied to a brake pedal BP, a pedal stroke sensor 72 for detecting a stroke of the brake pedal BP, a stop lump switch 73 for lighting on a stop lump when the brake pedal is depressed In a predetermined stroke, a shift lever position sensor 74 for detecting a position of a shift lever AL of an automatic transmission, a parking brake sensor 75 for detecting a parking brake operational condition, a pressure sensor 76 for detecting a pressing force of a male screw (spindle) 47 against a disc rotor 5, an ignition switch 77, a throttle sensor 78 for detecting a throttle opening amount and wheel speed sensors 79 provided on each wheels FL, FR, RL, RR via an amplification circuit 89. On the other hand, the output port 84 Is connected to electric motors 31 provided on each electronic controlled brake 1, 2, 3, 4 via a driving circuit 90.

The ROM 86 memorizes control programs for a normal brake control, an anti lock brake control (ABS control) and so on. The CPU 85 performs the control programs when the ignition switch 77 is turned on. The RAM 87 memorizes temporary parameter data which are necessary for performing the control programs. The CPU 85 corresponds to a judge circuit for judging whether the brake operation is carried out on the basis of the signals from the above mentioned sensors and switches.

As shown In FIG. 2, the electronic controlled brake 1 includes a disc rotor 5 which is rotated with the wheel (not shown), an inner pad 7 and an outer pad 8 which are disposed at inside and outside of the disc rotor 5, a mounting member 6 which Is fixed to the non rotational portion (not shown) of a vehicle and which receives a brake torque applied to the pads 7, 8 and a caliper member 9 which is supported on the mounting member 6 so as to be able to move in the axial direction of the disc rotor 5. The inner pad 7 and the outer pad 8 includes pad linings 7a, 8a and backing plates 7b, 8b on which the pad linings 7a, 8a are integrally connected, respectively.

The caliper member 9 includes a caliper outer side portion 10, a pad pressing mechanism 11 and a cover 13. The pad preasing mechanism 11 is fixed to the caliper outer side portion 10 by bolts (not shown) and the cover 13 is fixed to the pad pressing mechanism 11 by bolts (not shown).

The pad pressing mechanism 11l includes a housing 12, an electric motor 21, a planetary gear mechanism 40 which amplifiers the rotational torque of the electric motor 31 and a ball screw 45. The ball screw 45 includes a female screw 46 having a flange portion 46b which functions as a carrier of the planetary gear mechanism 40, the male screw 47 which the pressure sensor 76 is fixed to an one end thereof and balls 48, The numeral 61 is a boot which is interposed between the pressure sensor 76 and the caliper 9.

The electric motor 31 is a direct current brush less motor and includes a stator core 32a, stator coils 32b, a rotational shaft 33, magnets 34 fixed on the rotational shaft 33 and an angular sensor which is constituted by a detecting magnet 35 and a hole lC 37. The stator core 32a and the stator coils 32b are fixed on the inner surface of the housing 12. The rotational shaft 33 is rotatably supported on a cylindrical portion 46c of the female screw 46 via a bearing bush 53. The female screw 46 is rotatably supported in the housing 12 by bearings 51, 52. A gear is integrally formed as a sun gear 33a of the planetary gear unit 40 on the outer surface of the left end portion of the rotational shaft 33. When a plurality phases of stator coils 32b are selectively energized on the basis of the signal from the angular sensor, the electric motor 31 is rotated.

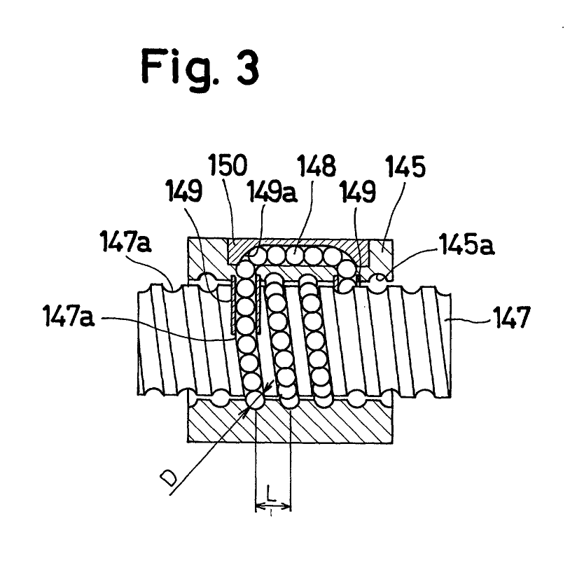

The planetary gear unit 40 includes the sun gear 33a, a ring gear 44 which Is fixed to the inner circumferential surface of the caliper outer side portion 10 and pinions 41 which are engaged with the ring gear 44 and the sun gear 33a and which are rotatably supported on a flange portion 46b of the female screw 46 via pins 42 and bushes 43. The female screw 46 functions as an output shaft of the planetary gear unit 40. the balls 48 are disposed between a screw groove 46a of the female screw 46 and a screw groove 47a of the male screw 47 and the ball screw 45 is formed. When the female screw 46 is rotated, the balls 48 are circulated by the circulator shown in FIG. 3 and the rotational movement of the female screw 46 is converted to the linear motion of the male screw 46. As a result, the ball screw 45 converts the rotational torque of the electric motor 31 amplified by the planetary gear unit 40 to the axial impulsive force of the male screw 47.

When the inner pad 7 Is pressed toward the disc rotor 5 by the male screw 47 due to the impulsive force of the male screw 47 (left ward) via the pressure sensor 76, simultaneously the caliper member 9 is pressed rightward by the reaction force. Thereby, the outer pad 8 is pressed against the disc rotor 5 by a nail portion 10a of the caliper outer side portion 10. Namely, the caliper member 9 and the male screw 47 are pressed in the counter direction each other and the inner pad 7 and the outer pad 8 are pressed against the disc rotor 5 by the male screw 47 and the nail portion 10a, respectively.

In the above mentioned electronic controlled brake device, at the initial condition shown In FIG. 2 in which the brake operation is not carried out, a clearance B is formed between the right end surface of the male screw 47 and a switch 80 of the cover 13. The distance of the clearance B is a length which has several times the lead of the ball screw 45. The switch 80 Is provided for preventing the male screw 47 from excessively moving rightward.

When the pedal depressing force detected by the pedal depressing force sensor 71 is less than a predetermined value, the CPU 85 judges that the brake operation is not carried out and an first idle operation of the electric motor 31 is carried out one or more times by the ECU 81 after the above judgment is done one or more times. In the first idle operation, the male screw 47 is moved from the initial position rightward in a predetermined distance (B−α(<B)) and thereafter is returned to the initial position.

Alternatively, when the pedal depressing force detected by the pedal depressing force sensor 71 is less than a predetermined value, the CPU 85 judges that the brake operation is not carried out and an second idle operation of the electric motor 31 is carried out one or more times by the ECU 81 after the above judgment is done one or more times. In the second idle operation, the male screw 47 is moved from the initial position rightward in a predetermined time and thereafter is returned to the initial position. The predetermined time is set to a time in which the right end surface of the male screw 47 does not contact with the switch 80 of the cover 13.

Further, when the pedal stroke detected by the pedal stroke sensor 72 is less than a predetermined value, the CPU 85 judges that the brake operation Is not carried out and the first idle operation of the electric motor 31 is carried out one or more times by the ECU 81 after the above judgment is done one or more times.

Alternatively, when the pedal stroke detected by the pedal stroke sensor 72 is less than a predetermined value, the CPU 85 judges that the brake operation is not carried out and the second idle operation of the electric motor 31 Is carried out one or more times by the ECU 81 after the above judgment is done one or more times.

Further, when the signal from the stop lump switch 73 is OFF, the CPU 85 judges that the brake operation Is not carried out and the first idle operation of the electric motor 31 is carried out one or more times by the ECU 81 after the above judgment is done one or more times.

Alternatively, when the signal from the stop lump switch 73 is OFF, the CPU 85 judges that the brake operation is not carried out and the second idle operation of the electric motor 31 is carried out one or more times by the ECU 81 after the above judgment Is done one or more times

Further, when it is detected by the shift lever position sensor 74 that the shift lever is in a P range position, the CPU 85 judges that the brake operation is not carried out and the first idle operation of the electric motor 31 is carried out one or more times by the ECU 81 after the above judgment is done one or more times.

Alternatively, When It Is detected by the shift lever position sensor 74 that the shift lever is in a P range position, the CPU 85 judges that the brake operation is not carried out and the second Idle operation of the electric motor 31 is carried out one or more times by the ECU 81 after the above judgment is, done one or more times.

Further, when, it is detected by the parking brake sensor 76 that the parking brake is operated, the CPU 85 judges that the brake operation is not carried out and the first Idle operation of the electric motor 31 is carried out one or more times by the ECU 81 after the above judgment is done one or more times.

Alternatively, when it is detected by the parking brake sensor 75 that the parking brake is operated, the CPU 85 judges that the brake operation is not carried out and the second idle operation of the electric motor 31 Is carried out one or more times by the ECU 21 after the above judgment is done one or more times.

Further, when the ECU 81 carries out an initial check lust after the ignition switch 77 is turned on, the CPU 85 judges that the brake operation Is not carried out and the first idle operation of the electric motor 31 is carried out one or more times by the ECU 51 after the above judgment is done one or more times.

Alternatively, when the ECU 81 carries out an initial check just after the ignition switch 77 is turned an, the CPU 85 judges that the brake operation is not carried out and the second idle operation of the electric motor 31 is carried out one or more times by the ECU 81 after the above judgment is done one or more times.

Further, when the throttle opening amount detected by the throttle sensor 78 is more than a predetermined value, the CPU 85 judges that the brake operation is not carried out and the first idle operation of the electric motor 31 is carried out one or more times by the ECU 81 after the above judgment is done one or more times.

Alternatively, when the throttle, opening amount detected by the throttle sensor 78 Is more than a predetermined value, the CPU 85 judges that the brake operation is not carried out and the second idle operation of the electric motor 31 is carried out one or more times by the ECU 81 after the above judgment is done one or more times.

According to this embodiment, when the male screw 47 carries out the above idle operation, the balls which can not proceed in the circulator at the brake operation are able to proceed In the circulator from the screw groove. Further, when the balls proceed in the circulator, the direction of the rotational axis thereof are changed and the portion contacting with the screw groove are changed. As a result, it is prevented that the balls wear partially and the durability of the ball screw 45 is improved.

According to the present invention, it is able to obtain an electronic controlled brake device which can improve the durability of the ball screw without increasing in size.

The principles, preferred embodiment and mode of operation of the present invention have been described in the foregoing specification. However, the invention which is intended to be protected is not to be construed as limited to the particular embodiment disclosed. Further, the embodiment described herein is to be regarded as Illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. An electronic controlled brake device comprising:
a ball screw for converting a rotational torque of an electric motor to an axial impulsive force of a spindle;
a brake pad pressed against a disc rotor by the axial Impulsive force of the spindle for generating a braking force;
electronic control means for controlling a drive of the electric motor and;
braking operation judging means for judging a braking operational condition,
wherein the spindle is moved from an initial position in a predetermined distance by the electric motor so as to back away from the disc rotor when the non braking operational condition is judged by braking operation judging means and thereafter is returned to the initial position by the electric motor.

2. An electronic controlled brake device as recited In claim 1, wherein the braking operation judging means include a brake depressing force sensor which detects a brake depressing force applied to a brake pedal and a judge circuit provided in the electronic control means, and the braking operation judging means judges that the brake operation is not carried out when the brake depression force detected by the brake depressing force sensor is less than a predetermined value.

3. An electronic controlled brake device as recited in claim 1, wherein the braking operation judging means include a pedal stroke sensor which detects a stroke of a brake pedal and a judge circuit provided in the electronic control means, and the braking operation judging means judges that the brake operation is not carried out when the pedal stroke detected by the pedal stroke sensor is less than a predetermined value.

4. An electronic controlled brake device as recited in claim 1, wherein the braking operation Judging means include a brake lump switch and a judge circuit provided in the electronic control means, and the braking operation judging means judges that the brake operation is not carried out when the brake lump switch is in OFF condition.

5. An electronic controlled brake device as recited in claim 1, wherein the braking operation judging means Include a shift lever position sensor for detecting a position of a shift lever of an automatic transmission and a judge circuit provided in the electronic control means, and the braking operation judging means judges that the brake operation is not carried out when the shift lever position detected by the shift lever position sensor is in a parking range position.

6. An electronic controlled brake device as recited in claim 1, wherein the braking operation judging means include a parking brake sensor for detecting a parking brake operational condition and a judge circuit provided in the electronic control means, and the braking operation judging means Judges that the brake operation is not carried out when the parking brake is operated.

7. An electronic controlled brake device as recited In claim 1, wherein the braking operation judging means include a judge circuit provided in the electronic control means and judges that the brake operation is not carried out when the electronic control means carries out an Initial check just after the Ignition switch is turned on.

8. An electronic controlled brake device comprising:
a ball screw for converting a rotational torque of an electric motor to an axial impulsive force of a spindle;
a brake pad pressed against a disc rotor by the axial impulsive force of the spindle for generating a braking force;
electronic control means for controlling a drive of the electric motor and,
braking operation judging means for judging a braking operational condition,
wherein the spindle is moved from an initial position in a predetermined time by the electric motor so as to back away from the disc rotor when the non braking operational condition is judged by braking operation judging means and thereafter is returned to the initial position by the electric motor.

9. An electronic controlled brake device as recited In claim 1, wherein the braking operation judging means include a brake depressing force sensor which detects a brake depressing force applied to a brake pedal and a judge circuit provided in the electronic control means, and the braking operation judging means judges that the brake operation is not carried out when the brake depression force detected by the brake depressing force sensor is less than a predetermined value.

10. An electronic controlled brake device as recited in claim 1, wherein the braking operation judging means Include a pedal stroke sensor which detects a stroke of a brake pedal and a judge circuit provided in the electronic control means, and the braking operation judging means judges that the brake operation Is not carried out when the pedal stroke detected by the pedal stroke sensor is less than a predetermined value.

11. An electronic controlled brake device as recited in claim 1, wherein the braking operation judging means Include a brake lump switch and a judge circuit provided in the electronic control means, and the braking operation judging means Judges that the brake operation is not carried out when the brake lump switch is in OFF condition.

12. An electronic controlled brake device as recited in claim 1, wherein the braking operation judging means include a shift lever position sensor for detecting a position of a shift lever of an automatic transmission and a judge circuit provided in the electronic control means, and the braking operation judging means judges that the-brake operation Is not carried out when the shift lever position detected by the shift lever position sensor Is In a parking range position.

13. An electronic controlled brake device as recited in claim 1, wherein the braking operation judging means include a parking brake sensor for detecting a parking brake operational condition and a judge circuit provided in the electronic control means, and the braking operation judging means judges that the brake operation is not carried out when the parking brake Is operated.

14. An electronic controlled brake device as recited in claim 1, wherein the braking operation judging means include a judge circuit provided in the electronic control means and judges that the brake operation is not carried out when the electronic control means carries out an Initial check just after the ignition switch is turned on.
